(19) United States
(12) Patent Application Publication
(10) Pub. No.: US 2022/0006677 A1
(43) Pub. Date: Jan. 6, 2022

(54) METHOD PERFORMED BY USER EQUIPMENT, AND USER EQUIPMENT

(71) Applicant: SHARP KABUSHIKI KAISHA, Sakai City, Osaka (JP)

(72) Inventors: CHAO LUO, Shanghai (CN); RENMAO LIU, Shanghai (CN)

(21) Appl. No.: 17/280,154

(22) PCT Filed: Sep. 20, 2019
(86) PCT No.: PCT/CN2019/107028

§ 371 Date: Mar. 25, 2021

(30) Foreign Application Priority Data
Sep. 27, 2018 (CN) 201811136810.4

(51) Int. Cl. H04L 27/26; H04L 5/00; H04W 76/14; H04W 56/00

(52) U.S. Cl. CPC H04L 27/261; H04L 27/2657; H04L 5/0044; H04L 5/001; H04W 76/14; H04W 56/0035; H04L 5/0057

(57) ABSTRACT

The present invention provides a method performed by user equipment, and user equipment. The method comprises: acquiring configuration information of a parameter related to generation of an Orthogonal Frequency Division Multiplexing (OFDM) baseband signal of a sidelink physical channel or signal; and generating the OFDM baseband signal of the sidelink physical channel or signal according to the acquired configuration information of the parameter, wherein the parameter comprises a frequency offset determining parameter for determining a frequency offset, so that the OFDM baseband signal of the sidelink, such as an OFDM baseband signal of a 5G sidelink, can be correctly generated.

### TECHNICAL FIELD

The present invention relates to the technical field of wireless communications, and in particular to a method performed by user equipment, a method performed by a base station, and corresponding user equipment.

### BACKGROUND

Device-to-Device (D2D) communication in a cellular network refers to direct communication between two mobile users without forwarding by a base station. (By contrast, in conventional cellular networks, all communication needs to be forwarded via base stations.)

Main scenarios of D2D communication can be classified as follows:
Out-of-Coverage: Both UEs performing D2D communication are out of network coverage (for example, the UE cannot detect any cell that meets a “cell selection criterion” on a frequency at which D2D communication needs to be performed).
In-Coverage: Both UEs performing D2D communication are in network coverage (for example, the UE detects at least one cell that meets a “cell selection criterion” on a frequency at which D2D communication needs to be performed). In this case, the two UEs may reside in the same ceil, or may reside in different cells respectively.
Partial-Coverage: One of two UEs performing D2D communication is out of network coverage, and the other is in network coverage.

In March 2014, at the 3rd Generation Partnership Project (3GPP) RAN #63 Plenary Session, a new work item (see Non-Patent Document 1, hereinafter briefly referred to as Rel-12 D2D) on implementation of D2D Proximity Services (ProSe) by using LTE device was approved. Functions introduced by Rel-12 D2D for the LTE system include:
a discovery function between ProSe devices in in-coverage scenarios;
a broadcast communication function between ProSe devices; and
broadcast communication based on the physical layer, and support for unicast and groupcast communication functions at high layers.

In December 2014, at the 3GPP RAN #66 Plenary Session, a new work item (see Non-Patent Document 2, hereinafter briefly referred to as Rel-13 D2D, or eD2D) to enhance the LTE D2D proximity services was approved. Functions introduced by Rel-13 D2D for the LTE system include:
a D2D discovery function in out-of-coverage and partial-coverage scenarios;
UE-to-network relay based on Rel-12 D2D communication; and
a priority handling mechanism for D2D communication.

In Rel-12 D2D and Rel-13 D2D, the interface between UE and UE for implementing D2D discovery and D2D communication is referred to as PC5, which is also referred to as “direct link” or “sidelink” at the physical layer, so as to distinguish it from uplink and downlink.

Vehicle-to-Everything (V2X) communication refers to communication between a vehicle and any entity that may affect the vehicle. Typical V2X communication includes Vehicle-to-Infrastructure (V2I), Vehicle-to-Network (V2N), Vehicle-to-Vehicle (V2V), Vehicle to Pedestrian (V2P), etc. The support for V2X in 3GPP standard protocols is based on the standardization work done by 3GPP Rel-12 D2D and 3GPP Rel-13 D2D.

In December 2015, at the 3GPP RAN #70 Plenary Session, a new work item (see Non-Patent Document 3, hereinafter briefly referred to as Rel-14 V2V, or V2X Phase 1) on using LTE sidelinks to support V2V services was approved. Functions introduced by Rel-14 V2V for the LTE system include:
introduction of more DM-RS symbols to support high-speed scenarios;
introduction of sub-channel, enhanced Scheduling Assignment (SA), and data resource design; and
introduction of a sensing mechanism with semi-persistent transmission for distributed scheduling.

In March 2017, at the 3GPP RAN #70 Plenary Session, a new work item (see Non-Patent Document 4, hereinafter briefly referred to as Rel-15 V2X, or V2X Phase 2) on the second phase of 3GPP V2X was approved. Functions introduced by Rel-15 V2X for the LTE system include:
support for Carrier Aggregation (CA) under distributed scheduling;
support for 64-QAM;
reduction of the time between packet arrival at the physical layer and transmission resource selection; and
radio resource pool sharing between UE using different scheduling modes.

As 5G (see Non-Patent Document 5, hereinafter referred to as Rel-15 NR, or NR, or Rel-155G) standardization work progresses, and the 3GPP has identified mom advanced V2X service (eV2X service) demands, 3GPP V2X phase 3, i.e., NR V2X is on the agenda. In June 2018, at the 3GPP RAN #80 Plenary Session, a new research project (see Non-Patent Document 6, hereinafter briefly referred to as Rel-16 V2X research project, or V2X Phase 3 research project) on 3GPP NR V2X was approved. One of the goals of the Rel-16 V2X research project is to study the design of new NR-based sidelink interfaces, including new sidelink synchronization mechanisms.

In the existing 3GPP standard specifications (i.e., prior to the Rel-16 V2X research project), such as the D2D and/or V2X standard specifications based on LTE, sidelink-based operations include sidelink discovery and sidelink communication. Both types of operations need to involve a sidelink synchronization mechanism. In addition, the V2X standard specifications enhance the sidelink communication operation and corresponding sidelink synchronization resource configuration in the D2D standard specifications. In the following, unless otherwise specified,
a “sidelink” in LTE mentioned refers to a sidelink for LTE V2X, for example, “sidelink communication” in LTE means sidelink communication for LTE V2X, and “sidelink synchronization” in LTE means sidelink synchronization for LTE V2X, etc.;
a “sidelink” in NR mentioned may refer to a sidelink for NR V2X, or may refer to a sidelink for other purposes, such as a sidelink in non-V2X D2D communication in NR.

LTE sidelinks use LTE uplink resources, and their physical layer channel structure design is also similar to that of LTE uplinks. The differences of them from the LTE uplinks include use of only single cluster transmission, and the last SC-FDMA symbol of each sidelink subframe being used as a Guard Period (GP), etc.

An LTE sidelink defines a Sidelink Synchronization Signal (SLSS), which is used for frequency and time synchronization between two UEs performing D2D and/or V2X communication, especially when at least one of them is out of network coverage, and one UE acquires a synchronization signal/channel transmitted by another UE. When one UE (denoted as UE1) selects an SLSS transmitted by the other UE (denoted as UE2) as a synchronization reference for sidelink transmission, it can be considered that UE2 is “synchronization reference UE” (or SyncRef UE) of UE1.

The SLSS carries an SLSS ID ranging from 0 to 335. An SLSS ID with a value set of {0, 1, . . . , 167} is used to indicate that the UE transmitting the SLSS is in network coverage or acquires the synchronization information from the UE in network coverage, and an SLSS ID with a value set of {168, 169, . . . , 335} is used to indicate that the UE transmitting the SLSS is out of network coverage and cannot acquire the synchronization information from the UE in network coverage. The SLSS includes a Primary Sidelink Synchronization Signal (PSSS) and an Secondary Sidelink Synchronization Signal (SSSS).
Time-frequency resources used by the PSSS occupy 62 subcarriers in the center of a sidelink carrier in the frequency domain, and occupy two adjacent SC-FDMA symbols in a subframe used for the PSSS in the time domain (for example, symbols 1 and 2 of the first slot in the subframe in the case of a normal cyclic prefix, assuming that symbols of each slot are numbered starting from 0), but exclude a Resource Element (RE) used for a reference signal therein.
Time-frequency resources used by the SSSS occupy 62 subcarriers in the center of the sidelink carrier in the frequency domain, and occupy two adjacent SC-FDMA symbols in a subframe used for the SSSS in the time domain (for example, symbols 4 and 5 of the second slot in the subframe in the case of a normal cyclic prefix, assuming that symbols of each slot are numbered starting from 0), but exclude an RE used for a reference signal therein.

The LTE sidelink also defines a Physical Sidelink Broadcast Channel (PSBCH), which is used to broadcast system information related to the sidelink.
Time-frequency resources used by the PSBCH occupy 72 subcarriers in the center of the sidelink carrier in the frequency domain, and occupy a subframe used for the PSBCH in the time domain, but exclude REs used for a reference signal and a synchronization signal therein. A corresponding transmission channel is referred to as a Sidelink Broadcast Channel (SL-BCH).
The sidelink-related system information transmitted on the SL-BCH can be an MasterInformationBlock-SL-V2X (MIB-SL-V2X, a sidelink master information block for V2X), including:
a configuration of transmission bandwidth, for example, by using a parameter sl-Bandwidth;
a TDD configuration, for example, by using a parameter tdd-ConfigSL;
a Direct Frame Number (DFN) where the SL-BCH (and the corresponding SLSS) transmitting the MIB-SL-V2X is located, for example, by using a parameter directFrameNumber;
a Direct Subframe Number (DSFN) where the SL-BCH (and the corresponding SLSS) transmitting the MIB-SL-V2X is located, for example, by using a parameter directSubframeNumber; and
a network coverage flag, indicating whether the UE transmitting the MIB-SL-V2X is in LTE network coverage, for example, by using a parameter inCoverage.

An LTE base station indicates the resource configuration information related to the V2X sidelink communication (including the corresponding sidelink synchronization configuration information) via a SystemInformationBlockType21 (SIB21, System Information Block 21). In addition, the UE can pre-configure a set of V2X sidelink parameters via a higher-layer protocol, for example, by using a parameter SL-V2X-Preconfiguration. The UE in network coverage can acquire the configuration information related to the V2X sidelink communication via the SIB21, and the UE out of network coverage can acquire the configuration information related to the V2X sidelink communication via the pre-configured V2X sidelink parameters and the MIB-SL-V2X sent by other UE.

An SC-FDMA baseband signal of an LTE uplink can be expressed as follows:

$${s}_{l}^{( p )} ( t ) = {\sum }_{k = - [ {N}_{RB}^{UL} {N}_{sc}^{RB} / 2 ]}^{[ {N}_{RB}^{UL} {N}_{sc}^{RB} / 2 ] - 1} {α}_{{k}^{( - )} , l}^{( p )} \cdot {e}^{j 2 π ( k + 1 / 2 ) Δ f ( t - {N}_{CP , l} {T}_{s} )}$$

where
0≤t≤(N_{CP,l}+N)×Tₛ;
N=2048;
Tₛ is a basic time unit of LTE; Tₛ=1/(15000×2048) seconds;
k⁽⁻⁾=k+└N_{RB}^{UL}N_{sc}^{RB}/2┘;
Δf=15 kHz;
p is an antenna port;
a_{k,l}^{(p)} is the content of a resource element (k, l) on the antenna port p;
l is the number of an SC-FDMA symbol in an uplink slot, SC-FDMA symbols in an uplink slot need to be transmitted in an ascending order of l, starting at l=0, and for an SC-FDMA symbol with l>0, its start lime is Σ_{l′=0}^{l-1}(N_{CP,l′}+N)Tₛ within the slot;
N_{RB}^{UL} is an uplink carrier bandwidth, in units of Resource Blocks (RBs);
N_{sc}^{RB} is an RB size in the frequency domain, represented by the quantity of subcarriers, N_{sc}^{RB}=12;
for an extended cyclic prefix, and l=0, 1, . . . , 5, N_{CP,l}=512;
for a normal cyclic prefix, and l=0, N_{CP,l}=160; and
for a normal cyclic prefix, and l=1, 2, . . . , 6, N_{CP,l}=144.

an SC-FDMA baseband signal generating method for the LTE sidelink (including LTE D2D and LTE V2X) follows the LTE uplink SC-FDMA baseband signal generating method, with the following changes:
N_{RB}^{UL} is replaced with N_{RB}^{SL} (sidelink carrier bandwidth); and
the length (N_{CP,l}) of a cyclic prefix of each sidelink channel or signal may be configured to be different from the length of an uplink cyclic prefix.

The configuration information related to the V2X sidelink communication acquired by the UE contains necessary parameters for generating an SC-FDMA baseband signal of the sidelink synchronization channel or signal, including the sidelink carrier bandwidth N_{RB}^{SL}, and the corresponding cyclic prefix length (N_{CP,l}). In addition, as mentioned above, the positions of the resource elements occupied by the PSSS, the SSSS, and the PSBCH (indexed by (k, l)) relative to the center of the sidelink carrier in the frequency domain are fixed, and the symbol positions in the subframe in the time domain are also fixed.

By contrast, in 5G, the use of a plurality of numerologies (which, unless otherwise specified, refer to subcarrier spacing, or refer to the combination of subcarrier spacing and cyclic prefix length) in one cell is supported. The waveform numerology supported by 5G is as shown in Table 1, which defines two types of cyclic prefixes, “normal” and “extended”.

TABLE 1
Waveform numerology supported by 5 G

| μ | Δf = 2^{μ} · 15 [kHz] | Cyclic prefix |
|---|---|---|
| 0 | 15 | Normal |
| 1 | 30 | Normal |
| 2 | 60 | Normal, extended |
| 3 | 120 | Normal |
| 4 | 240 | Normal |

In 5G, on a carrier in a given transmission direction (denoted as x, where x=DL represents downlink, and x=UL represents uplink or supplementary uplink), for each waveform numerology μ (configured by a high-layer parameter subcarrierSpacing), a resource grid (also referred to as a subcarrier specific carrier (SCS-specific carrier)) is defined, which contains N_{grid,x}^{size,μ}N_{sc}^{RB} subcarriers (i.e., N_{grid,x}^{size,μ} resource blocks, each resource block containing N_{sc}^{RB} subcarriers) in the frequency domain, and contains N_{symb}^{subframe,μ} OFDM symbols in the time domain (i.e., the number of OFDM symbols in one subframe, the specific value of which is related to μ), where N_{sc}^{RB} refers to the quantity of subcarriers in one Resource Block (RB, which can be numbered by common resource blocks or physical resource blocks), N_{sc}^{RB}=12. A lowest-numbered Common Resource Block (CRB) N_{grid,x}^{size,μ} of the resource grid is configured by a higher-layer parameter offsetToCarrier, and the quantity of frequency domain resource blocks N_{grid,x}^{size,μ} is configured by a higher-layer parameter carrierBandwidth. Where
The common resource block is defined for a waveform numerology. For example, for μ=0 (i.e., Δf=15 kHz), the size of one common resource block is 15×12=180 kHz, and for μ=1 (i.e., Δf=30 kHz), the size of one common resource block is 30×12×360 kHz.
For all waveform numerologies, the center frequency of subcarrier 0 of common resource block 0 points to the same position in the frequency domain. This position is also referred to as “point A”.

All subcarrier spacing configurations defined in a carrier and their corresponding resource grids can be configured by a parameter scs-SpecificCarrierList.

In 5G, for each waveform numerology, one or a plurality of “Bandwidth Parts” (BWPs) can be defined. Each BWP contains one or a plurality of consecutive common resource blocks. Assuming that the number of a certain BWP is i, its starting point N_{BWP,l}^{start,μ} and length N_{BWP,i}^{size,μ} need to satisfy the following relationships at the same time:

N_{grid,x}^{start,μ}≤N_{BWP,l}^{start,μ}<N_{grid,x}^{start,μ}+N_{grid,x}^{size,μ}

N_{grid,x}^{start,μ}<N_{BWP,i}^{size,μ}+N_{BWP,i}^{start,μ}≤N_{grid,x}^{start,μ}+N_{grid,x}^{size,μ}.

That is, common resource blocks contained in the BWP need to be located in a corresponding resource grid, N_{BWP,i}^{start,μ} uses a common resource block number, that is, it represents the distance from a lowest-numbered resource block of the BWP to “point A” (represented by the quantity of resource blocks).

In 5G, resource blocks in a BWP are also referred to as “Physical Resource Blocks (PRBs),” and their numbers are 0˜N_{BWP,i}^{size,μ}−1, among which physical resource block 0 is the lowest-numbered resource block of the BWP, corresponding to a common resource block N_{BWP,i}^{size,μ}. Uplink and downlink BWPs used by UE during initial access are referred to as an initial active uplink BWP and an initial active downlink BWP, respectively, and uplink and downlink BWPs used during non-initial access (i.e., cases other than initial access) are referred to as an active uplink BWP and an active downlink BWP, respectively.

In 5G, the number of subcarriers in one resource block is 0˜N_{sc}^{RB}−1 (that is, the lowest-numbered subcarrier is subcarrier 0, and the highest-numbered subcarrier is subcarrier N_{sc}^{RB}−1), regardless of whether the resource block uses a common resource block number or a physical resource block number.

In 5G, in the time domain, both an uplink and a downlink are composed of a plurality of radio frames (or system frames, sometimes referred to as frames, numbered from 0 to 1023) with a length of 10 ms. Each frame contains 10 subframes with a length of 1 ms (numbered from 0 to 9 in the frame), and each subframe contains Nₛₗₒₜ^{subframe,μ} slots (numbered 0˜Nₛₗₒₜ^{subframe,μ}−1 in the subframe), and each slot contains N_{symb}^{slot} OFDM symbols. Table 2 shows the values of N_{symb}^{slot} and Nₛₗₒₜ^{subframe,μ} in different subcarrier spacing configurations. Obviously, the quantity of OFDM symbols in each subframe N_{symb}^{subframe,μ}=N_{symb}^{slot}Nₛₗₒₜ^{subframe,μ}.

TABLE 2
Time domain parameters related to subcarrier spacing configuration μ

| μ | N_{symb}^{slot} | Nₛₗₒₜ^{subframe,μ} |
|---|---|---|
| 0 | 14 | 1 |
| 1 | 14 | 2 |
| 2 | 14 | 4 |
| 3 | 14 | 8 |
| 4 | 14 | 16 |

The basic time unit of 5G is T_{c}=1/(Δfₘₐₓ·N_{f}), where Δfₘₐₓ=480·10³ Hz and N_{f}=4096. The constant κ=Tₛ/T_{c}=64, where Tₛ=1/(Δf_{ref}·N_{f,ref}), Δ_{f,ref}=15·10³ Hz, N_{f,ref}=2048.

Where there is no potential of confusion, the x representing a transmission direction in the subscript of a mathematical symbol can be removed. For example, for a given downlink physical channel or signal, N_{grid}^{size,μ} can be used to represent the quantity of resource blocks of a resource grid in the frequency domain corresponding to the subcarrier spacing configuration μ.

In the existing 3GPP standard specifications on 5G, an OFDM baseband signal generating formula for physical channels or signals other than a Physical Random-Access Channel (PRACH) can be expressed as

$${s}_{l}^{( p , μ )} ( t ) = {\sum }_{k = 0}^{{N}_{grid}^{size , μ} {N}_{sc}^{RB} - 1} {α}_{k , l}^{( p , μ )} \cdot {e}^{j 2 π ( k + {k}_{o}^{μ} - {N}_{grid}^{size , μ} {N}_{sc}^{RB} / 2 ) Δ f ( t - {N}_{CP , l}^{μ} {T}_{c} - {t}_{start , l}^{μ} )}$$

where
p is an antenna port;
μ is the subcarrier spacing configuration, and Δf is its corresponding subcarrier spacing, see Table 1;
l is the number of an OFDM symbol in one subframe, l∈{0, 1, . . . , Nₛₗₒₜ^{subframe,μ}N_{symb}^{slot}−1};
k₀^{μ}=(N_{grid}^{start,μ}+N_{grid}^{size,μ}/2)N_{sc}^{RB}−(N_{grid}^{start,μ}^{ₒ}+N_{grid}^{size,μ}^{ₒ}/2)N_{sc}^{RB}2^{μ}^{ₒ}^{-μ};
t_{start,l}^{μ}≤t<t_{start,l}^{μ}+(Nᵤ^{μ}+N_{CP,l}^{μ})T_{c};
for l=0, t_{start,l}^{μ}=0;
for l≠0, t_{start,l}^{μ}=t_{start,l-1}^{μ}+(Nᵤ^{μ}+N_{CP,l-1}^{μ})T_{c};
Nᵤ^{μ}=2048κ·2^{-μ};
for an extended cyclic prefix, N_{CP,l}^{μ}=512κ·2^{-μ};
for a normal cyclic prefix, and l=0 or l=7·2^{μ}, N_{CP,l}^{μ}=144κ·2^{-μ}+16κ;
for a normal cyclic prefix, and l≠0 and l≠7·2^{μ}, N_{CP,l}^{μ}=144κ·2^{-μ}; and
μ₀ is the maximum in subcarrier spacing configurations for corresponding carriers provided to UE, such as the maximum in all subcarrier spacing configurations configured in a higher-layer parameter scsSpecificCarrierList (also referred to as scs-SpecificCarrierList).

It can be seen that the generation of the OFDM baseband signal for both the uplink and downlink in 5G needs to calculate a shift k₀^{μ}, and the calculation of k₀^{μ} requires the following inputs:
configuration parameters of the resource grid corresponding to the subcarrier spacing configuration (μ) used by the OFDM baseband signal, that is, the subcarrier spacing configuration (μ), the lowest-numbered common resource block (N_{grid}^{start,μ}), and the quantity of frequency domain resource blocks (N_{grid}^{size,μ}); and
configuration parameters of the resource grid corresponding to the maximum (μ₀) in all the subcarrier spacing configurations configured in the higher-layer parameter scsSpecificCarrierList, that is, the subcarrier spacing configuration (μ₀), the lowest-numbered common resource block (N_{grid}^{start,μ}^{₀}), and the quantity of frequency domain resource blocks (N_{grid}^{size,μ}^{₀}).

5G sidelinks can continue to use the OFDM baseband signal generating method of physical channels or signals in 5G other than PRACH, with only necessary changes in parameter configurations.

In the case of a 5G sidelink and a 5G uplink sharing one carrier, the OFDM baseband signal generation of both needs to use the same k₀^{μ} value. On the other hand, because sets of subcarrier spacing configurations used by the 5G sidelink and the 5G uplink may be different (assuming that the set of subcarrier spacing configurations used by the former is A, and the set of subcarrier spacing configurations used by the latter is B), UE (such as UE out of network coverage) cannot infer the maximum subcarrier spacing configuration in set B and the corresponding resource grid configuration when only knowing the set of subcarrier spacing configurations of the 5G sidelink, i.e., set A. As a result, the UE cannot acquire the parameter k₀^{μ}, required for generation of an OFDM baseband signal of the 5G sidelink, and cannot correctly generate the OFDM baseband signal of the 5G sidelink.

In addition, in order to correctly implement operations such as modulation and upconversion, a method is desired to acquire configuration information of parameters related to a 5G sidelink carrier configuration so as to determine an RF reference frequency of the 5G sidelink carrier.

### PRIOR ART DOCUMENT

### Non-Patent Document

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-170855, New WID on New Radio Access Technology
Non-Patent Document 6. RP-181429, New SID: Study on NR V2X

### SUMMARY

In order to solve at least part of the aforementioned problems, the present invention provides a method performed by user equipment, and user equipment, which can correctly generate an OFDM baseband signal of a sidelink, such as an OFDM baseband signal of a 5G sidelink. In addition, the present invention provides a method performed by user equipment, and user equipment, which can correctly determine an RF reference frequency of a 5G sidelink.

According to the present invention, a method performed by user equipment is provided, including: acquiring configuration information of a parameter related to generation of an Orthogonal Frequency Division Multiplexing (OFDM) baseband signal of a sidelink physical channel or signal; and generating the OFDM baseband signal of the sidelink physical channel or signal according to the acquired configuration information of the parameter, where the parameter includes a frequency offset determining parameter for determining a frequency offset.

In the foregoing method, it is possible that the frequency offset determining parameter is a parameter used to indicate the frequency offset, and the frequency offset is determined according to the parameter used to indicate the frequency offset, or the frequency offset is directly given by the parameter used to indicate the frequency offset.

In the foregoing method, it is possible that the frequency offset determining parameter includes a parameter used to indicate a reference subcarrier spacing configuration and a configuration parameter used to indicate a reference resource grid corresponding to the reference subcarrier spacing configuration.

In the foregoing method, it is possible that the configuration parameter used to indicate the reference resource grid corresponding to the reference subcarrier spacing configuration includes: a parameter used to indicate a number of a lowest-numbered common resource block of the reference resource grid, and a parameter used to indicate the quantity of frequency domain resource blocks of the reference resource grid.

In the foregoing method, it is possible that the frequency offset k₀^{μ} can be calculated according to the following formula;

k₀^{μ}=(N_{grid}^{start,μ}+N_{grid}^{size,μ}/2)N_{sc}^{RB}−(N_{grid}^{start,μ}^{₀}+N_{grid}^{size,μ}^{₀}/2)N_{sc}^{RB}2^{μ}^{₀}^{-μ}

where

μ₀ is determined by the parameter used to indicate the reference subcarrier spacing configuration, or is directly given by the parameter;

N_{grid}^{start,μ}^{₀} is determined by the parameter indicating the number of the lowest-numbered common resource block of the reference resource grid, or directly given by the parameter; and
N_{grid}^{size,μ}^{₀} is determined by the parameter indicating the quantity of frequency domain resource blocks of the reference resource grid, or is directly given by the parameter.

In the foregoing method, it is possible that the frequency offset determining parameter is acquired via any one of Downlink Control Information (DCI), a Medium Access Control Control Element (MAC CE), Radio Resource Control (RRC) signaling, and pre-defined or pre-configured information.

In the foregoing method, it is possible that if both a frequency offset determining parameter contained in a master information block of a sidelink and a frequency offset determining parameter contained in pre-defined or pre-configured information of the sidelink are acquired, ether one thereof is used.

According to the present invention, a method performed by user equipment is provided, including: acquiring configuration information of a parameter related to an uplink carrier or a supplementary uplink carrier; determining, according to the acquired configuration information of the parameter, a parameter related to generation of an Orthogonal Frequency Division Multiplexing (OFDM) baseband signal of a sidelink physical channel or signal; and transmitting system information related to a sidelink, where the determined parameter includes a frequency offset determining parameter used to determine a frequency offset, and the system information includes the frequency offset determining parameter.

According to the present invention, a method performed by user equipment is provided, including: acquiring configuration information of a parameter related to an uplink carrier or a supplementary uplink carrier; acquiring configuration information of a parameter related to generation of an Orthogonal Frequency Division Multiplexing (OFDM) baseband signal of a sidelink physical channel or signal; determining, according to the acquired configuration information of the parameter related to the uplink carrier or the supplementary uplink carrier and the configuration information of the parameter related to the generation of the OFDM baseband signal of the sidelink physical channel or signal, configuration information of other parameters related to the generation of the OFDM baseband signal of the sidelink physical channel or signal; and transmitting system information related to a sidelink, where the determined parameter includes a frequency offset determining parameter used to determine a frequency offset, and the system information includes the frequency offset determining parameter.

According to the present invention, a method performed by user equipment is provided, including: acquiring configuration information of a parameter related to a sidelink carrier configuration; and determining, according to the acquired configuration information, an RF reference frequency of a corresponding sidelink carrier.

According to the present invention, user equipment is provided, including: a processor; and a memory, storing instructions, where the instructions, when executed by the processor, perform the foregoing method.

### Effect of Invention

According to the method performed by user equipment and the user equipment of the present invention, an OFDM baseband signal of a sidelink, such as an OFDM baseband signal of a 5G sidelink, can be correctly generated. In addition, according to the method performed by user equipment and the user equipment of the present invention, an RF reference frequency of a sidelink carrier can be correctly determined.

### BRIEF DESCRIPTION OF THE DRAWINGS

The above and other features of the present invention will be more pronounced through the following detailed description taken in conjunction with the accompanying drawings.

FIG. 1 is a flowchart showing a method performed by user equipment according to Embodiment 1 of the present invention.

FIG. 2 is a flowchart showing a method performed by user equipment according to Embodiment 2 of the present invention.

FIG. 3 is a flowchart showing a method performed by user equipment according to Embodiment 3 of the present invention.

FIG. 4 is a flowchart showing a method performed by user equipment according to Embodiment 4 of the present invention.

FIG. 5 is a flowchart showing a method performed by user equipment according to Embodiment 5 of the present invention.

FIG. 6 is a flowchart showing a method performed by user equipment according to Embodiment 6 of the present invention.

FIG. 7 is a flowchart showing a method performed by user equipment according to Embodiment 7 of the present invention.

FIG. 8 is a block diagram showing user equipment according to the present invention.

### DETAILED DESCRIPTION

The following describes the present invention in detail with reference to the accompanying drawings and specific embodiments. It should be noted that the present invention is not limited to the specific embodiments described below. In addition, for simplicity, detailed description of the known art not directly related to the present invention is omitted to prevent confusion with respect to the understanding of the present invention.

In the following description, a 5G mobile communication system and its subsequently evolved versions are used as illustrative application environments to set forth a plurality of embodiments according to the present invention in detail. However, it is to be noted that the present invention is not limited to the following embodiments, and rather, it is applicable to many other wireless communication systems, such as a communication system later than 5G and a 4G mobile communication system earlier than the 5G.

Some terms involved in the present invention are described below. Unless otherwise specified, the terms used in the present invention adopt the definitions herein. The terms given in the present invention may be named differently in LTE, LTE-Advanced, LTE-Advanced Pro, NR, and later communication systems, but unified terms are adopted in the present invention. When applied to a specific system, the terms may be replaced with terms adopted in the corresponding system.
3GPP: 3rd Generation Partnership Project
BWP: Bandwidth Part
CA: Carrier Aggregation
CP-OFDM: Cyclic Prefix Orthogonal Frequency Division Multiplexing
CRB: Common Resource Block, physical resource block
CSI-RS: Channel-State Information Reference Signal
DFT-s-OFDM: Discrete Fourier Transformation Spread Orthogonal Frequency Division Multiplexing
D2D: Device-to-Device
DCI: Downlink Control Information
DFN: Direct Frame Number
DM-RS: Demodulation Reference Signal
DSFN: Direct Subframe Number
eMBB: Enhanced Mobile Broadband, enhanced mobile broadband communication
GP: Guard Period
IE: Information Element
LTE: Long Term Evolution
LTE-A: Long Term Evolution-Advanced
MAC: Medium Access Control
MAC CE: MAC Control Element
mMTC: Massive Machine Type Communication
NR: New Radio
OFDM: Orthogonal Frequency Division Multiplexing
PBCH: Physical Broadcast Channel
PDCCH: Physical Downlink Control Channel
PDSCH: Physical Downlink Shared Channel
PRACH: Physical random-access channel
PRB: Physical Resource Block
ProSe: Proximity Services
PSBCH: Physical Sidelink Broadcast Channel
PSCCH: Physical Sidelink Control Channel
PSDCH: Physical Sidelink Discovery Channel
PSSCH: Physical Sidelink Shared Channel
PSSS: Primary Sidelink Synchronization Signal
PT-RS: Phase-Tracking Reference Signal
PUCCH: Physical Uplink Control Channel
PUSCH: Physical Uplink Shared Channel
RAP: Random Access Preamble
RB: Resource Block
RE: Resource Element
RF: Radio Frequency
RRC: Radio Resource Control
SA: Scheduling Assignment
SC-FDMA: Single-Carrier Frequency-Division Multiple Access
SIB: System Information Block
SL-BCH: Sidelink Broadcast Channel
SLSS: Sidelink Synchronization Signal
SRS: Sounding Reference Signal
SSB: Synchronization Signal/Physical Broadcast Channel (SS/PBCH) Block
SSSS: Secondary Sidelink Synchronization Signal
SUL: Supplementary Uplink
TDD. Time Division Duplexing
UE: User Equipment
URLLC: Ultra-Reliable and Low Latency Communication
V2I: Vehicle-to-Infrastructure
V2N: Vehicle-to-Network
V2P: Vehicle-to-Pedestrian
V2V: Vehicle-to-Vehicle
V2X: Vehicle-to-Everything

Unless otherwise specified, in all embodiments and implementations of the present invention,
the use and interpretation of mathematical symbols and mathematical expressions follow those in the prior art. For example,
N_{sc}^{RB} refers to the quantity of subcarriers in a resource block (such as a common resource block or a physical resource block), N_{sc}^{RB}=12.

### Embodiment 1

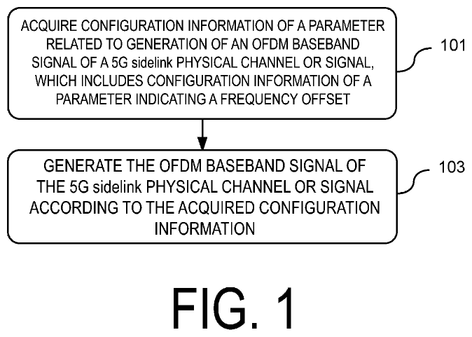

FIG. 1 is a flowchart showing a method performed by user equipment according to Embodiment 1 of the present invention.

In Embodiment 1 of the present invention, the steps performed by user equipment (UE) comprise:

In step 101, configuration information of a parameter related to generation of an OFDM baseband signal of a 5G sidelink physical channel or signal (for example, whether the parameter has been configured or a value configured for the parameter) is acquired. For example, the configuration information of the parameter is acquired from pre-defined information or pre-configured information, or the configuration information of the parameter is acquired from a base station, or the configuration information of the parameter is acquired from other UE. The parameter includes:
A parameter sl-FreqOffset0 used to indicate a frequency offset.

For example, the configuration information of the parameter sl-FreqOffset0 is acquired via DCI.

For another example, the configuration information of the parameter sl-FreqOffset0 is acquired via a MAC CE.

For another example, the configuration information of the parameter sl-FreqOffset0 is acquired via RRC signaling. For example, the configuration information of the parameter sl-FreqOffset0 contained in a master information block (such as an MIB-SL transmitted on a PSBCH) of a 5G sidelink is acquired.

For another example, the configuration information of the parameter sl-FreqOffset0 is pro-defined, for example, sl-FreqOffset0=0.

For another example, the configuration information of the parameter sl-FreqOffset0 is acquired via pre-con figured information. For example, the configuration information of the parameter sl-FreqOffset0 contained in pre-configured information (such as SL-Preconfiguration) of the 5G sidelink is acquired.

For another example, if the configuration information of the parameter sl-FreqOffset0 contained in the master information block of the 5G sidelink and the configuration information of the parameter sl-FreqOffset0 contained in the pre-defined or pre-configured information of the 5G sidelink are both acquired, the configuration information of the parameter sl-FreqOffset0 contained in the master information block of the 5G sidelink is used (that is, the configuration information of the parameter sl-FreqOffset0 contained in the pre-defined or pre-configured information of the 5G sidelink is discarded).

For another example, if both the configuration information of the parameter sl-FreqOffset0 contained in the master information block of the 5G sidelink and the configuration information of the parameter sl-FreqOffset0 contained in the pre-defined or pre-configured information of the 5G sidelink are acquired, the configuration information of the parameter sl-FreqOffset0 contained in the pre-defined or pre-configured information of the 5G sidelink is used (that is, the configuration information of the parameter sl-FreqOffset0 contained in the master information block of the 5G sidelink is discarded).

In step 103, the OFDM baseband signal of the 5G sidelink physical channel or signal is generated according to the configuration information of the parameter related to the generation of the OFDM baseband signal of the 5G sidelink physical channel or signal. For example, the OFDM baseband signal of the 5G sidelink physical channel or signal may be expressed, by using a time-continuous signal as sₗ^{(p,μ)}(t), as

$${s}_{l}^{( p , μ )} ( t ) = {\sum }_{k = 0}^{{N}_{grid}^{size , μ} {N}_{sc}^{RB} - 1} {α}_{k , l}^{( p , μ )} \cdot {e}^{j 2 π ( k + {k}_{0}^{μ} - {N}_{grid}^{size , μ} {N}_{sc}^{RB} / 2 ) Δ f ( t - {N}_{CP , l}^{μ} {T}_{c} - {t}_{start , l}^{μ} )}$$

where
p is an antenna port;
μ is the subcarrier spacing configuration, and Δf is its corresponding subcarrier spacing, see Table 1;
l is the number of an OFDM symbol in one subframe, l∈{0, 1, . . . , Nₛₗₒₜ^{subframe,μ}N_{symb}^{slot}−1};
t_{start,l}^{μ}≤t<t_{start,l}^{μ}+(Nᵤ^{μ}+N_{CP,l}^{μ})T_{c};
for l=0, t_{start,l}^{μ}=0;
for l≠0, t_{start,l}^{μ}=t_{start,l-1}^{μ}+(Nᵤ^{μ}+N_{CP,l-1}^{μ})T_{c};
Nᵤ^{μ}=2048κ·2^{-μ};
for an extended cyclic prefix, N_{CP,l}^{μ}=512κ·2^{-μ};
for a normal cyclic prefix, and l=0 or l=7·2^{μ}, N_{CP,l}^{μ}=144κ·2^{-μ}+16κ;
for a normal cyclic prefix, and l≠0 and l≠7·2^{μ}, N_{CP,l}^{μ}=144κ·2^{-μ}; and
k₀^{μ} represents the frequency offset, which is determined by the parameter sl-FreqOffset0, or is directly given by the parameter sl-FreqOffset0.

Embodiment 1 of the present invention is suitable for UE to generate an OFDM baseband signal of a 5G sidelink physical channel or signal. The 5G sidelink physical channel or signal may include a PSSS, an SSSS, a PSBCH, a PSCCH, a PSDCH, a PSSCH, etc.

As described above, the method performed by the user equipment in Embodiment 1 of the present invention includes: acquiring configuration information of a parameter related to generation of an OFDM baseband signal of a sidelink physical channel or signal; and generating, according to the acquired configuration information of the parameter, the OFDM baseband signal of the sidelink physical channel or signal, where the parameter includes a frequency offset determining parameter used to determine a frequency offset. The frequency offset determining parameter may be, for example, a parameter for indicating the frequency offset.

According to the foregoing method, since the parameter related to the generation of the OFDM baseband signal of the sidelink physical channel or signal acquired by the UE includes the frequency offset determining parameter used to determine the frequency offset, even UE out of network coverage can correctly generate the OFDM baseband signal of the sidelink according to the acquired frequency offset determining parameter. In this way, for example, in case that sets of subcarrier spacing configurations used by the 5G sidelink and a 5G uplink or supplementary uplink are different, the UE can still correctly generate the OFDM baseband signal of the 5G sidelink, so as to share a carrier in the 5G sidelink and the 5G uplink or supplementary uplink, thereby improving the utilization efficiency of communication resources.

### Embodiment 2

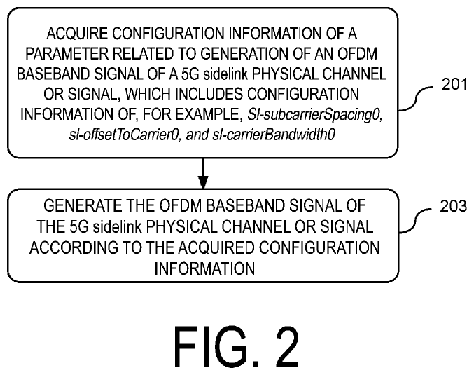

FIG. 2 is a flowchart showing a method performed by user equipment according to Embodiment 2 of the present invention.

In Embodiment 2 of the present invention, the steps performed by user equipment (UE) comprise:

In step 201, configuration information of a parameter related to generation of an OFDM baseband signal of a 5G sidelink physical channel or signal (for example, whether the parameter has been configured or a value configured for the parameter) is acquired. For example, the configuration information of the parameter is acquired from pre-defined information or pre-con figured information, or the configuration information of the parameter is acquired from a base station, or the configuration information of the parameter is acquired from other UE. The parameter includes:
a parameter sl-subcarrierSpacing0 used to indicate a reference subcarrier spacing configuration; and
a configuration parameter used to indicate a reference resource grid corresponding to the reference subcarrier spacing configuration, which, for example, includes:
a parameter sl-offsetToCarrier0 used to indicate a number of a lowest-numbered common resource block of the reference resource grid; and
a parameter sl-carrierBandwidth0 used to indicate the quantity of frequency domain resource blocks of the reference resource grid.

For example, the configuration information of one or a plurality of the parameters sl-subcarrierSpacing0, sl-offsetToCarrier0, and sl-carrierBandwidth0 is acquired via DCI.

For another example, the configuration information of one or a plurality of the parameters sl-subcarrierSpacing0, sl-offsetToCarrier0, and sl-carrierBandwidth0 is acquired via a MAC CE.

For another example, the configuration information of one or a plurality of the parameters sl-subcarrierSpacing0, sl-offsetToCarrier0, and si-carrierBandwidth0 is acquired via RRC signaling. For example, the configuration information of one or a plurality of the parameters sl-subcarrierSpacing0, sl-offsetToCarrier0, and sl-carrierBandwidth0 contained in a master information block (such as an MIB-SL transmitted on a PSBCH) of a 5G sidelink is acquired.

For another example, the configuration information of one or a plurality of the parameters sl-subcarrierSpacing0, sl-offsetToCarrier0, and sl-carrierBandwidth0 is pre-defined. For example,
sl-subcarrierSpacing0=0, and/or
sl-offsetToCarrier0=0, and/or
sl-carrierBandwidth0=275.

For another example, the configuration information of one or a plurality of the parameters sl-subcarrierSpacing0, sl-offsetToCarrier0, and sl-carrierBandwidth0 is acquired via pre-configured information. For example, the configuration information of one or a plurality of the parameters sl-subcarrierSpacing0, sl-offsetToCarrier0, and sl-carrierBandwidth0 contained in pre-configured information (such as SL-Preconfiguration) of the 5G sidelink is acquired.

For another example, if the configuration information of one or a plurality of the parameters sl-subcarrierSpacing0, sl-offsetToCarrier0, and sl-carrierBandwidth0 contained in the master information block of the 5G sidelink and the configuration information of one or a plurality of the parameters sl-subcarrierSpacing0, sl-offsetToCarrier0, and sl-carrierBandwidth0 contained in the pre-defined or pre-configured information of the 5G sidelink are both acquired, the configuration information of the corresponding parameter contained in the master information block of the 5G sidelink is used (that is, the configuration information of the corresponding parameter in the pre-defined or pre-configured information of the 5G sidelink is discarded).

For another example, if the configuration information of one or a plurality of the parameters sl-subcarrierSpacing0, sl-offsetToCarrier0, and sl-carrierBandwidth0 contained in the master information block of the 5G sidelink and the configuration information of one or a plurality of the parameters sl-subcarrierSpacing0, sl-offsetToCarrier0, and sl-carrierBandwidth0 contained in the pre-defined or pre-configured information of the 5G sidelink are both acquired, the configuration information of the parameter contained in the pre-defined or pre-configured information of the 5G sidelink is used (that is, the configuration information of the corresponding parameter contained in the master information block of the 5G sidelink is discarded).

In step 203, the OFDM baseband signal of the 5G sidelink physical channel or signal is generated according to the configuration information of the parameter related to the generation of the OFDM baseband signal of the 5G sidelink physical channel or signal, for example, the OFDM baseband signal of the 5G sidelink physical channel or signal may be expressed, by using a time-continuous signal sₗ^{(p,μ)}(t), as

$${s}_{l}^{( p , μ )} ( t ) = {\sum }_{k = 0}^{{N}_{grid}^{size , μ} {N}_{sc}^{RB} - 1} {α}_{k , l}^{( p , μ )} \cdot {e}^{j 2 π ( k + {k}_{o}^{μ} - {N}_{grid}^{size , μ} {N}_{sc}^{RB} / 2 ) Δ f ( t - {N}_{CP , l}^{μ} {T}_{c} - {t}_{start , l}^{μ} )}$$

Regarding the items in the above calculation formula, the description of the same items as those in Embodiment 1 is omitted.

Where
k₀^{μ} is calculated by using the following formula:

k₀^{μ}=(N_{grid}^{start,μ}+N_{grid}^{size,μ}/2)N_{sc}^{RB}−(N_{grid}^{start,μ}^{₀}+N_{grid}^{size,μ}^{₀}/2)N_{sc}^{RB}2^{μ}^{₀}^{-μ},
where
μ₀ is determined by the parameter sl-subcarrierSpacing0, or is directly given by the parameter sl-subcarrierSpacing0;
N_{grid}^{start,μ}^{₀} is determined by the parameter sl-offsetToCarrier0, or is directly given by the parameter sl-offsetToCarrier0: and
N_{grid}^{size,μ}^{₀} is determined by the parameter sl-carrierBandwidth0, or is directly given by the parameter sl-carrierBandwidth0;

Embodiment 2 of the present invention is suitable for UE to generate an OFDM baseband signal of a 5G sidelink physical channel or signal. The 5G sidelink physical channel or signal may include a PSSS, an SSSS, a PSBCH, a PSCCH, a PSDCH, a PSSCH, etc.

According to the method in Embodiment 2 above, as in Embodiment 1, the UE can correctly generate the OFDM baseband signal of the 5G sidelink, so as to share a carrier in the 5G sidelink and a 5G uplink or supplementary uplink, thereby improving the utilization efficiency of communication resources.

### Embodiment 3

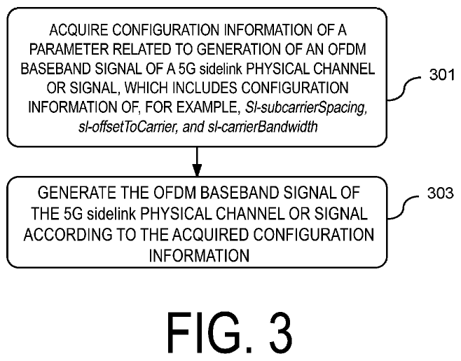

FIG. 3 is a flowchart showing a method performed by user equipment according to Embodiment 3 of the present invention.

In Embodiment 3 of the present invention, the user equipment (UE) performs the following steps:

In step 301, configuration information of a parameter related to generation of an OFDM baseband signal of a 5G sidelink physical channel or signal (for example, whether the parameter has been configured or a value configured for the parameter) is acquired. For example, the configuration information of the parameter is acquired from pre-defined information or pre-configured information, or the configuration information of the parameter is acquired from a base station, or the configuration information of the parameter is acquired from other UE. The parameter includes:
a parameter sl-subcarrierSpacing used to indicate a subcarrier spacing configuration used by the OFDM baseband signal of the 5G sidelink physical channel or signal; and
a configuration parameter used to indicate a resource grid corresponding to the subcarrier spacing configuration, which, for example, includes:
a parameter sl-offsetToCarrier used to indicate a number of a lowest-numbered common resource block of the resource grid; and
sl-carrierBandwidth used to indicate the quantity of frequency domain resource blocks of the resource grid.

For example, the configuration information of one or a plurality of the parameters sl-subcarrierSpacing, sl-offsetToCarrier, and sl-carrierBandwidth is acquired via DCI.

For another example, the configuration information of one or a plurality of the parameters sl-subcarrierSpacing, sl-offsetToCarrier, and sl-carrierBandwidth is acquired via a MAC CE.

For another example, the configuration information of one or a plurality of the parameters sl-subcarrierSpacing, sl-offsetToCarrier, and sl-carrierBandwidth is acquired via RRC signaling. For example, the configuration information of one or a plurality of the parameters sl-subcarrierSpacing, sl-offsetToCarrier, and sl-carrierBandwidth contained in a master information block (such as an MIB-SL transmitted on a PSBCH) of a 5G sidelink is acquired.

For another example, the configuration information of one or a plurality of the parameters sl-subcarrierSpacing, sl-offsetToCarrier, and sl-carrierBandwidth is pre-defined. For example,
sl-subcarrierSpacing=0, and/or
sl-offsetToCarrier=0, and/or
sl-carrierBandwidth=275.

For another example, the configuration information of one or a plurality of the parameters sl-subcarrierSpacing, sl-offsetToCarrier, and sl-carrierBandwidth is acquired via pre-configured information. For example, the configuration information of one or a plurality of the parameters sl-subcarrierSpacing, sl-offsetToCarrier, and sl-carrierBandwidth contained in pre-configured information (such as SL-Preconfiguration) of the 5G sidelink is acquired.

For another example, if the configuration information of one or a plurality of the parameters sl-subcarrierSpacing, sl-offsetToCarrier, and sl-carrierBandwidth contained in the master information block of the 5G sidelink and the configuration information of one or a plurality of the parameters sl-subcarrierSpacing, sl-offsetToCarrier, and sl-carrierBandwidth contained in the pre-defined or pre-configured information of the 5G sidelink are both acquired, the configuration information of the corresponding parameter contained in the master information block of the 5G sidelink is used (that is, the configuration information of the corresponding parameter in the pre-defined or pre-configured information of the 5G sidelink is discarded).

For another example, if the configuration information of one or a plurality of the parameters sl-subcarrierSpacing, sl-offsetToCarrier, and sl-carrierBandwidth contained in the master information block of the 5G sidelink and the configuration information of one or a plurality of the parameters sl-subcarrierSpacing, sl-offsetToCarrier, and sl-carrierBandwidth contained in the pre-defined or pre-configured information of the 5G sidelink are both acquired, the configuration information of the parameter contained in the pre-defined or pre-configured information of the 5G sidelink is used (that is, the configuration information of the corresponding parameter contained in the master information block of the 5G sidelink is discarded).

In step 303, the OFDM baseband signal of the 5G sidelink physical channel or signal is generated according to the configuration information of the parameter related to the generation of the OFDM baseband signal of the 5G sidelink physical channel or signal. For example, the OFDM baseband signal of the 5G sidelink physical channel or signal may be expressed, by using a time-continuous signal sₗ^{(p,μ)}(t), as

$${s}_{l}^{( p , μ )} ( t ) = {\sum }_{k = 0}^{{N}_{grid}^{size , μ} {N}_{sc}^{RB} - 1} {α}_{k , l}^{( p , μ )} \cdot {e}^{j 2 π ( k + {k}_{o}^{μ} - {N}_{grid}^{size , μ} {N}_{sc}^{RB} / 2 ) Δ f ( t - {N}_{CP , l}^{μ} {T}_{c} - {t}_{start , l}^{μ} )}$$

Regarding the items in the above calculation formula, the description of the same items as those in Embodiment 1 is omitted.

Where
μ is determined by the parameter sl-subcarrierSpacing, or is directly given by the parameter sl-subcarrierSpacing;
N_{grid}^{start,μ} and is a number of a lowest-numbered common resource block of a resource grid corresponding to μ; N_{grid}^{start,μ} is determined by the parameter sl-offsetToCarrier, or is directly given by the parameter sl-offsetToCarrier;
N_{grid}^{size,μ} grid is the quantity of frequency domain resource blocks of the resource grid corresponding to μ; N_{grid}^{size,μ} is determined by the parameter sl-carrierBandwidth, or is directly given by the parameter sl-carrierBandwidth; and

k₀^{μ}=(N_{grid}^{start,μ}+N_{grid}^{size,μ}/2)N_{sc}^{RB}−(N_{grid}^{start,μ}^{₀}+N_{grid}^{size,μ}^{₀}/2)N_{sc}^{RB}2^{μ}^{₀}^{-μ}.

Embodiment 3 of the present invention is suitable for UE to generate an OFDM baseband signal of a 5G sidelink physical channel or signal. The 5G sidelink physical channel or signal may include a PSSS, an SSSS, a PSBCH, a PSCCH, a PSDCH, a PSSCH, etc.

According to the method in Embodiment 3 above, as in Embodiment 1, the UE can correctly generate the OFDM baseband signal of the 5G sidelink, so as to share a carrier in the 5G sidelink and a 5G uplink or supplementary uplink, thereby improving the utilization efficiency of communication resources.

### Embodiment 4

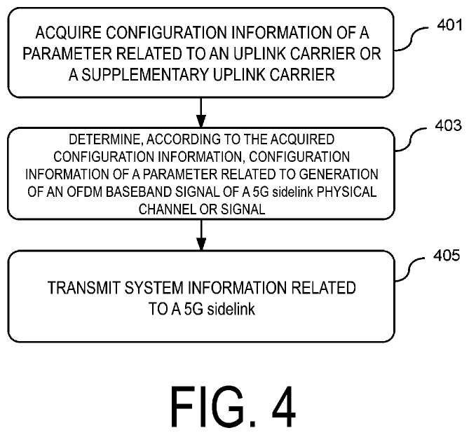

FIG. 4 is a flowchart showing a method performed by user equipment according to Embodiment 4 of the present invention.

In Embodiment 4 of the present invention, the user equipment (UE) performs the following steps:

In step 401, configuration information of a parameter related to an uplink carrier or a supplementary uplink carrier (for example, whether the parameter has been configured, or a value configured for the parameter) is acquired. For example, the configuration information of the parameter is acquired from pre-defined information or pre-configured information, or the configuration information of the parameter is acquired from a base station, or the configuration information of the parameter is acquired from other UE. The parameter includes:
configuration information of a waveform numerology related to the uplink carrier or the supplementary uplink carrier and a corresponding resource grid, which is configured, for example, via a Frequency InfoUL-SIB IE or a parameter scs-SpecificCarrierList in the Frequency InfoUL-SIB IE.

In step 403, configuration information of a parameter related to generation of an OFDM baseband signal of a 5G sidelink physical channel or signal is determined according to the configuration information of the parameter related to the uplink carrier or the supplementary uplink carrier.
For example, a reference subcarrier spacing configuration sl-subcarrierSpacing0 is determined according to the maximum value μ₀ in all subcarrier spacing configurations configured in the parameter scs-SpecificCarrierList, and a number sl-offsetToCarrier0 of a lowest-numbered common resource block of a resource grid corresponding to the reference subcarrier spacing configuration and the quantity sl-carrierBandwidth0 of frequency domain resource blocks of the resource grid corresponding to the reference subcarrier spacing configuration are respectively determined according to a number N_{grid}^{start,μ}^{₀} of a lowest-numbered common resource block and the quantity N_{grid}^{start,μ}^{₀} of frequency domain resource blocks of a resource grid corresponding to μ₀.

In step 405, system information, for example, an MIB-SL, related to a 5G sidelink is transmitted. The system information related to the 5G sidelink includes configuration information of one or a plurality of the following parameters:
the reference subcarrier spacing configuration sl-subcarrierSpacing0;
the number sl-offsetToCarrier0 of the lowest-numbered common resource block of the resource grid corresponding to the reference subcarrier spacing configuration; and
the quantity sl-carrierBandwidth0 of frequency domain resource blocks of the resource grid corresponding to the reference subcarrier spacing configuration.

According to the method in Embodiment 4 above, since the determined parameter related to the generation of the OFDM baseband signal of the sidelink physical channel or signal includes the frequency offset determining parameter used to determine the frequency offset, and the system information includes the configuration information of the frequency offset determining parameter, the UE receiving the system information can correctly generate, for example, an OFDM baseband signal of a 5G sidelink according to the configuration information of the frequency offset determining parameter, so as to share a carrier in the 5G sidelink and the 5G uplink or supplement uplink, thereby improving the utilization efficiency of communication resources.

### Embodiment 5

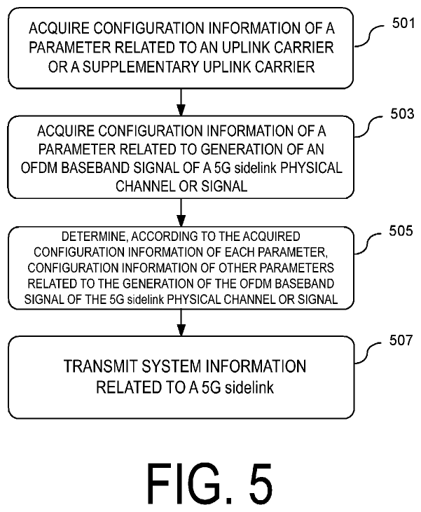

FIG. 5 is a flowchart showing a method performed by user equipment according to Embodiment 5 of the present invention.

In Embodiment 5 of the present invention, the user equipment (UE) performs the following steps:

In step 501, configuration information of a parameter related to an uplink carrier or a supplementary uplink carrier (for example, whether the parameter has been configured, or a value configured for the parameter) is acquired. For example, the configuration information of the parameter is acquired from pre-defined information or pre-configured information, or the configuration information of the parameter is acquired from a base station, or the configuration information of the parameter is acquired from other UE. The parameter includes:
configuration information of a waveform numerology related to the uplink carrier or the supplementary uplink carrier and a corresponding resource grid, which is configured, for example, via a FrequencyInfoUL-SIB IE or a parameter scs-SpecificCarrierList in the FrequencyInfoUL-SIB IE.

In step 503, configuration information of a parameter related to generation of an OFDM baseband signal of a 5G sidelink physical channel or signal is acquired. For example, the configuration information of the parameter is acquired from pre-defined information or pre-configured information, or the configuration information of the parameter is acquired from a base station, or the configuration information of the parameter is acquired from other UE. The parameter includes:
a subcarrier spacing configuration μ used by the 5G sidelink physical channel or signal, and a number N_{grid}^{start,μ} of a lowest-numbered common resource block and the quantity N_{grid}^{size,μ} of frequency domain resource blocks of a resource grid corresponding to μ.

In step SOS, configuration information of other parameters related to the generation of the OFDM baseband signal of the 5G sidelink physical channel or signal is determined according to the configuration information of the parameter related to the uplink carrier or the supplementary uplink carrier and the configuration information of the parameter related to the generation of the OFDM baseband signal of the 5G sidelink physical channel or signal. The other parameters related to the generation of the OFDM baseband signal of the 5G sidelink physical channel or signal include:
frequency offset k₀^{μ}

For example, the value of the frequency offset k₀^{μ} calculated, according to the maximum value μ₀ in all subcarrier spacing configurations configured in the parameter scs-SpecificCarrierList, a number N_{grid}^{start,μ}^{₀} and of a lowest-numbered common resource block and the quantity N_{grid}^{size,μ}^{₀} of frequency domain resource blocks of a resource grid corresponding to μ₀, the subcarrier spacing configuration μ used by the 5G sidelink physical channel or signal, and the number N_{grid}^{start,μ} of the lowest-numbered common resource block and the quantity N_{grid}^{size,μ} of frequency domain resource blocks of the resource grid corresponding to μ, via the following formula:

k₀^{μ}=(N_{grid}^{start,μ}+N_{grid}^{size,μ}/2)N_{sc}^{RB}−(N_{grid}^{start,μ}^{₀}+N_{grid}^{size,μ}^{₀}/2)N_{sc}^{RB}2^{μ}^{₀}^{-μ}

and the value of the frequency offset parameter sl-FreqOffset0 is determined according to the value of k₀^{μ}, for example, sl-FreqOffset0=k₀^{μ}.

In step 507, system information, for example, an MIB-SL, related to a 5G sidelink is transmitted. The system information related to the 5G sidelink includes configuration information of the following parameter:
frequency offset sl-FreqOffset0.

According to the method in Embodiment 5 above, as in Embodiment 4, this enables the UE receiving the system information to correctly generate, for example, an OFDM baseband signal of a 5G sidelink, so as to share a carrier in the 5G sidelink and a 5G uplink or supplementary uplink, thereby improving the utilization efficiency of communication resources.

### Embodiment 6

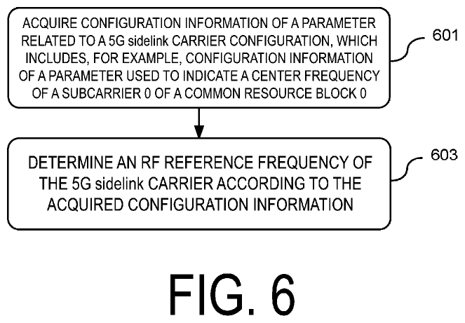

FIG. 6 is a flowchart showing a method performed by user equipment according to a Embodiment 6 of the present invention.

In Embodiment 6 of the present invention, the user equipment (UE) performs the following steps:

In step 601, configuration information of a parameter related to a 5G sidelink carrier configuration (for example, whether the parameter has been configured or a value configured for the parameter) is acquired. For example, the configuration information of the parameter is acquired from pre-defined information or pre-configured information, or the configuration information of the parameter is acquired from a base station, or the configuration information of the parameter is acquired from other UE. The parameter includes:
A center frequency (i.e., “point A”) of sub-carrier 0 of common resource block 0, which is configured, for example, by using a parameter sl-absoluteFrequencyPointA, and for example, its type is ARFCN-ValueNR.

For example, the configuration information of the parameter sl-absoluteFrequencyPointA is acquired via DCI.

For another example, the configuration information of the parameter sl-absoluteFrequencyPointA is acquired via a MAC CE.

For another example, the configuration information of the parameter sl-absoluteFrequentyPointA is acquired via RRC signaling. For example, the configuration information of the parameter sl-absoluteFrequencyPointA contained in a master information block (such as an MIB-SL transmitted on a PSBCH) of a 5G sidelink is acquired.

For another example, the configuration information of the parameter sl-absoluteFrequencyPointA is pre-defined.

For another example, the configuration information of the parameter sl-absoluteFrequencyPointA is acquired via pre-con figured information. For example, the configuration information of the parameter sl-absoluteFrequencyPointA contained in pre-configured information (such as SL-Preconfiguration) of the 5G sidelink is acquired.

For another example, if the configuration information of the parameter sl-absoluteFrequencyPointA contained in the master information block of the 5G sidelink and the configuration information of the parameter sl-absoluteFrequencyPointA contained in the pre-defined or pre-configured information of the 5G sidelink are both acquired, the configuration information of the parameter sl-absoluteFrequencyPointA contained in the master information block of the 5G sidelink is used (that is, the configuration information of the parameter sl-absoluteFrequencyPointA contained in the pre-defined or pre-configured information of the 5G sidelink is discarded).

For another example, if the configuration information of the parameter si-absoluteFrequencyPointA contained in the master information block of the 5G sidelink and the configuration information of the parameter sl-absoluteFrequencyPointA contained in the pre-defined or pre-configured information of the 5G sidelink are both acquired, the configuration information of the parameter sl-absoluteFrequencyPointA contained in the pre-defined or pre-configured information of the 5G sidelink is used (that is, the configuration information of the parameter sl-absoluteFrequencyPointA contained in the master information block of the 5G sidelink is discarded).

In step 603, an RF reference frequency of the corresponding 5G sidelink carrier is determined according to the configuration information of the parameter related to the the 5G sidelink carrier configuration.

For example, the RF reference frequency of the 5G sidelink carrier is determined according to the parameter sl-absoluteFrequencyPointA and, for example, the reference subcarrier spacing configuration μ₀ and the number N_{grid}^{start,μ}^{₀} of the lowest-numbered common resource block and the quantity N_{grid}^{size,μ}^{₀} of frequency domain resource blocks of the resource grid corresponding to μ₀. For example, if N_{grid}^{size,μ}^{₀} mod=0, the RF reference frequency of the 5G sidelink carrier corresponds to a center frequency of subcarrier 0 in a common resource block with a number of

$${N}_{grid}^{start , {μ}_{o}} + ⌊ \frac{{N}_{grid}^{size , {μ}_{o}}}{2} ⌋ ,$$

that is, the RF reference frequency of the 5G sidelink carrier is equal to the frequency indicated by the parameter sl-absoluteFrequencyPointA plus bandwidth (using μ₀ as the subcarrier spacing configuration) occupied by

$${N}_{grid}^{start , {μ}_{o}} + ⌊ \frac{{N}_{grid}^{size , {μ}_{o}}}{2} ⌋ \cdot {N}_{sc}^{RB}$$

subcarriers; if N_{grid}^{size,μ}^{₀} mod 2=1, the RF reference frequency of the 5G sidelink carrier corresponds to a center frequency of subcarrier 6 in a common resource block with a number of

$${N}_{grid}^{start , {μ}_{0}} + ⌊ \frac{{N}_{grid}^{size , {μ}_{0}}}{2} ⌋ ,$$

that is, the RF reference frequency of the 5G sidelink carrier is equal to the frequency indicated by the parameter sl-absoluteFrequencyPointA plus bandwidth (using pa as the subcarrier spacing configuration) occupied by

$$( {N}_{grid}^{start , {μ}_{0}} + ⌊ \frac{{N}_{grid}^{size , {μ}_{0}}}{2} ⌋ ) \cdot {N}_{sc}^{RB} + 6$$

subcarriers.

For another example, the RF reference frequency of the 5G sidelink carrier is determined according to the parameter sl-absoluteFrequencyPointA, the frequency offset k₀^{μ} as determined, for example, in the steps in Embodiment 1 or Embodiment 2, and the subcarrier spacing configuration μ used by the OFDM baseband signal of the 5G sidelink physical channel or signal and the number N_{grid}^{start,μ} of the lowest-numbered common resource block and the quantity N_{grid}^{size,μ} of frequency domain resource blocks of the resource grid corresponding to μ as determined, for example, in the steps in Embodiment 3. For example, if N_{grid}^{size,μ} mod 2=0, the RF reference frequency of the 5G sidelink carrier corresponds to a frequency offsetting −k₀^{μ} subcarriers from a center frequency of subcarrier 0 in a common resource block with a number of

$${N}_{grid}^{start , μ} + ⌊ \frac{{N}_{grid}^{size , μ}}{2} ⌋ ,$$

that is, the RF reference frequency of the 5G sidelink carrier is equal to the frequency indicated by the parameter sl-absoluteFrequencyPointA plus bandwidth (using μ as the subcarrier spacing configuration) occupied by

$$( {N}_{grid}^{start , μ} + ⌊ \frac{{N}_{grid}^{size , μ}}{2} ⌋ ) \cdot {N}_{sc}^{RB} - {k}_{0}^{μ}$$

subcarriers; if N_{grid}^{size,μ} mod 2=1, the RF reference frequency of the 5G sidelink carrier corresponds to a frequency offsetting −k₀^{μ} subcarriers from a center frequency of subcarrier 6 in a common resource block with a number of

$${N}_{grid}^{start , μ} + ⌊ \frac{{N}_{grid}^{size , μ}}{2} ⌋ ,$$

that is, the RF reference frequency of the 5G sidelink carrier is equal to the frequency indicated by the parameter sl-absoluteFrequencvPointA plus bandwidth (using μ as the subcarrier spacing configuration) occupied by

$$( {N}_{grid}^{start , μ} + ⌊ \frac{{N}_{grid}^{size , μ}}{2} ⌋ ) \cdot {N}_{sc}^{RB} + 6 - {k}_{0}^{μ}$$

subcarriers.

According to the method in Embodiment 6 above, since the determined configuration information of the parameter related to the 5G sidelink carrier configuration includes the parameter for determining the center frequency of subcarrier 0 of common resource block 0, this enables the UE acquiring the parameter to correctly determine the RF reference frequency of the 5G sidelink carrier, so as to correctly implement operations such as modulation and upconversion.

### Embodiment 7

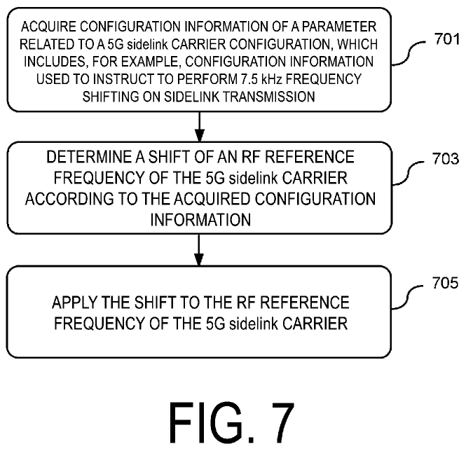

FIG. 7 is a flowchart showing a method performed by user equipment according to Embodiment 7 of the present invention.

In Embodiment 7 of the present invention, the user equipment (UE) performs the following steps:

In step 701, configuration information of a parameter related to a 5G sidelink carrier configuration (for example, whether the parameter has been configured, or a value configured for the parameter) is acquired. For example, the configuration information of the parameter is acquired from pre-defined information or pre-configured information, or the configuration information of the parameter is acquired from a base station, or the configuration information of the parameter is acquired from other UE. The parameter includes:
an instruction to perform 7.5 kHz frequency shifting on sidelink transmission, for example, to perform configuration via a parameter sl-frequencyShift7p5 khz.

For example, the configuration information of the parameter sl-frequencyShift7p5 khz is acquired via DCI.

For another example, the configuration information of the parameter sl-frequencyShift7p5 khz is acquired via a MAC CE.

For another example, the configuration information of the parameter sl-frequencyShift7p5 khz is acquired via RRC signaling. For example, the configuration information of the parameter sl-frequencyShift7p5 khz contained in a master information block (such as an M/B-SL transmitted on a PSBCH) of a 5G sidelink is acquired.

For another example, the configuration information of the parameter sl-frequencyShift7p5 khz is pre-defined, for example, sl-frequencyShift7p5 khz is not configured.

For another example, the configuration information of the parameter sl-frequencyShift7p5 khz is acquired via pre-configured information. For example, the configuration information of the parameter sl-frequencyShift7p5 khz contained in pre-configured information (such as SL-Preconfiguration) of the 5G sidelink is acquired.

For another example, if the configuration information of the parameter sl-frequencyShift 7p5 khz contained in the master information block of the 5G sidelink and the configuration information of the parameter sl-frequencyShift7p5 khz contained in the pre-defined or pre-configured information of the 5G sidelink are both acquired, the configuration information of the parameter sl-frequencyShift7p5 khz contained in the master information block of the 5G sidelink is used (that is, the configuration information of the parameter sl-frequencyShift7p5 khz contained in the pre-defined or pre-configured information of the 5G sidelink is discarded).

For another example, if the configuration information of the parameter sl-frequencyShift7p5 khz contained in the master information block of the 5G sidelink and the configuration information of the parameter sl-frequencyShift7p5 khz contained in the pre-defined or pre-configured information of the 5G sidelink are both acquired, the configuration information of the parameter sl-frequencyShift7p5 khz contained in the pre-defined or pre-configured information of the 5G sidelink is used (that is, the configuration information of the parameter sl-frequencyShift7p5 khz contained in the master information block of the 5G sidelink is discarded).

In step 703, a shift Δ_{shift} of an RF reference frequency of the corresponding 5G sidelink carrier is determined according to the configuration information of the parameter related to the 5G sidelink carrier configuration.

For example, if the parameter frequencyShift7p5 khz is not configured, the shift Δ_{shift}=0 kHz; if the parameter frequencyShift7p5 khz is configured, the shift Δ_{shift}=7.5 kHz.

In step 705, the shift Δ_{shift} is applied to the RF reference frequency of the 5G sidelink carrier, for example:

F_{REF_shift}=F_{REF}+Δ_{shift}.

Optionally, Embodiment 7 of the present invention is only applied to an SUL frequency band and frequency bands n1, n2, n3, n5, n7, n8, n20, n28, n66, and n71.

According to the method in Embodiment 7 above, since the determined configuration information of the parameter related to the 5G sidelink carrier configuration includes the parameter used to instruct to perform 7.5 kHz frequency shifting on the sidelink transmission, this enables the UE acquiring the parameter to correctly determine the RF reference frequency of the 5G sidelink carrier, so as to correctly implement operations such as modulation and upconversion.

Any one of the foregoing embodiments and implementations may be applied to one 5G sidelink carrier, or may be applied to a plurality of 5G sidelink carriers respectively.

Each of the above-described examples and embodiments can be combined with each other if no contradiction is caused. For example, as described in Embodiment 6, Embodiment 6 and Embodiment 2 can be used in combination.

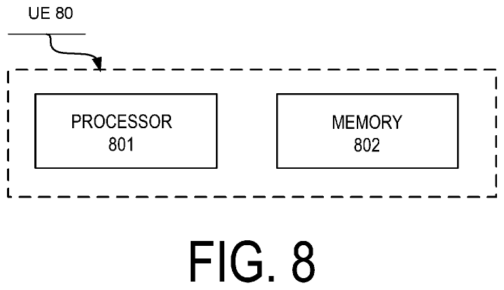

FIG. 8 is a block diagram showing User Equipment (UE) involved in the present invention. As shown in FIG. 8, the user equipment (UE) 80 includes a processor 801 and a memory 802. The processor 801 may include, for example, a microprocessor, a microcontroller, an embedded processor, etc. The memory 802 may include, for example, a volatile memory (for example, a Random Access Memory (RAM)), a Hard Disk Drive (HDD), a non-volatile memory (for example, a flash memory), or other memories. The memory 802 stores program instructions. When the instructions are executed by the processor 801, the aforementioned method executable by user equipment as described in detail in the present invention can be implemented.

The methods and related devices according to the present invention have been described above in conjunction with the preferred embodiments. Those skilled in the art can understand that the methods shown above are only exemplary, and the various embodiments described above can be combined with one another as long as no contradiction arises. The method of the present invention is not limited to steps or sequences illustrated above. The network node and the user equipment illustrated above may include more modules; for example, they may further include modules which can be developed or developed in the future to be applied to modules of a base station, an MME, or UE. Various identifiers shown above are only exemplary, and are not meant for limiting the present invention. The present invention is not limited to specific information elements serving as examples of these identifiers. Those skilled in the art can make various alterations and modifications according to the teachings of the illustrated embodiments.

It should be understood that the embodiments above of foe present invention can be implemented by software, hardware or a combination of the software and the hardware. For example, various components inside the base station and the user equipment in the embodiments above can be implemented by various devices, and these devices include, but are not limited to: an analog circuit device, a digital circuit device, a Digital Signal Processor (DSP) circuit, a programmable processor, an Application Specific Integrated Circuit (ASIC), a Field Programmable Gate Array (FPGA), a Complex Programmable Logic Device (CPLD) and the like.

In this application, the “base station” may refer to a mobile communication data and control exchange center with large transmission power and a wide coverage area, including functions such as resource allocation and scheduling, data reception and transmission. “User equipment” may refer to a user mobile terminal, for example, including terminal devices that can communicate with a base station or a micro base station wirelessly, such as a mobile phone, a laptop computer, and the like.

Moreover, the embodiments of the present invention disclosed herein can be implemented on a computer program product. More particularly, the computer program product is a product as follows: a product having a computer readable medium encoded with computer program logic thereon, when being executed on a computing equipment, the computer program logic provides related operations to implement foe technical solution of the prevent invention. When being executed on at least one processor of a computing system, the computer program logic enables the processor to execute the operations (methods) described in the embodiments of the present invention. Such setting of the present invention is typically provided as software, codes and/or other data structures provided or encoded on the computer readable medium, e.g., an optical medium (e.g., Compact Disc Read Only Memory (CD-ROM)), a flexible disk or a hard disk and the like, or other media such as firmware or micro codes on one or more Read Only Memory (ROM) or Random Access Memory (RAM) or Programmable Read Only Memory (PROM) chips, or a downloadable software image, a shared database and the like in one or more modules. The software or the firmware or such configuration can be installed on the computing equipment, so that one or more processors in the computing equipment execute the technical solution described in the embodiments of the present invention.

In addition, each functional module or each feature of the base station device and the terminal device used in each of the above embodiments may be implemented or executed by a circuit, which is usually one or a plurality of integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The above-mentioned general purpose processor or each circuit may be configured with a digital circuit or may be configured with a logic circuit. In addition, when an advanced technology that can replace current integrated circuits emerges due to advances in semiconductor technology, the present invention may also use integrated circuits obtained using this advanced technology.

Although the present invention is already illustrated above in conjunction with the preferred embodiments of the present invention, those skilled in the art should understand that, without departing from the spirit and scope of the present invention, various modifications, replacements and changes can be made to the present invention. Therefore, the present invention should not be defined by the above embodiments, but should be defined by the appended claims and equivalents thereof.

1. A method performed by user equipment, comprising:
acquiring configuration information of a parameter related to generation of an Orthogonal Frequency Division Multiplexing (OFDM) baseband signal of a sidelink physical channel or signal; and
generating the OFDM baseband signal of the sidelink physical channel or signal according to the acquired configuration information of the parameter, wherein
the parameter comprises a frequency offset determining parameter for determining a frequency offset.

2. The method according to claim 1, wherein
the frequency offset determining parameter is a parameter used to indicate the frequency offset, and the frequency offset is determined according to the parameter used to indicate the frequency offset, or the frequency offset is directly given by the parameter used to indicate the frequency offset.

3. The method according to claim 1, wherein
the frequency offset determining parameter comprises a parameter used to indicate a reference subcarrier spacing configuration and a configuration parameter used to indicate a reference resource grid corresponding to the reference subcarrier spacing configuration.

4. The method according to claim 3, wherein
the configuration parameter used to indicate the reference resource grid corresponding to the reference subcarrier spacing configuration comprises: a parameter used to indicate a number of a lowest-numbered common resource block of the reference resource grid, and a parameter used to indicate the quantity of frequency domain resource blocks of the reference resource grid.

5. The method according to claim 4, wherein
the frequency offset k₀^{μ} is calculated according to the following formula:
k₀^{μ}=(N_{grid}^{start,μ}+N_{grid}^{size,μ}/2)N_{sc}^{RB}−(N_{grid}^{start,μ}^{₀}+N_{grid}^{size,μ}^{₀}/2)N_{sc}^{RB}2^{μ}^{₀}^{-μ},
where
μ₀ is determined by the parameter used to indicate the reference subcarrier spacing configuration, or is directly given by the parameter;
N_{grid}^{start,μ}^{₀} is determined by the parameter used to indicate the number of the lowest-numbered common resource block of the reference resource grid, or is directly given by the parameter; and
N_{grid}^{size,μ}^{₀} is determined by the parameter used to indicate the quantity of frequency domain resource blocks of the reference resource grid, or is directly given by the parameter.

6. The method according to claim 1, wherein
the frequency offset determining parameter is acquired via any one of Downlink Control Information (DCI), a Medium Access Control Control Element (MAC CE), Radio Resource Control (RRC) signaling, and pre-defined or pre-configured information.

7. The method according to claim 1, wherein
if a frequency offset determining parameter contained in a master information block of a sidelink and a frequency offset determining parameter contained in pre-defined or pre-configured information of the sidelink are both acquired, ether one thereof is used.

8. A method performed by user equipment, comprising:
acquiring configuration information of a parameter related to an uplink carrier or a supplementary uplink carrier,
determining, according to the acquired configuration information of the parameter, a parameter related to generation of an Orthogonal Frequency Division Multiplexing (OFDM) baseband signal of a sidelink physical channel or signal; and
transmitting system information related to a sidelink, wherein
the determined parameter comprises a frequency offset determining parameter used to determine a frequency offset, and
the system information comprises configuration information of the frequency offset determining parameter.

9. A method performed by user equipment, comprising:
acquiring configuration information of a parameter related to an uplink carrier or a supplementary uplink carrier;
acquiring configuration information of a parameter related to generation of an Orthogonal Frequency Division Multiplexing (OFDM) baseband signal of a sidelink physical channel or signal;
determining, according to the acquired configuration information of the parameter related to the uplink carrier or the supplementary uplink carrier and the configuration information of the parameter related to the generation of the OFDM baseband signal of the sidelink physical channel or signal, configuration information of other parameters related to the generation of the OFDM baseband signal of the sidelink physical channel or signal; and
transmitting system information related to a sidelink, wherein
the determined parameter comprises a frequency offset determining parameter used to determine a frequency offset, and
the system information comprises configuration information of the frequency offset determining parameter.

10. User equipment, comprising:
a processor; and
a memory storing instructions;
wherein the method according to any one of claims 1 to 9 is implemented when the instructions are executed by the processor.
